(19) United States
(12) Patent Application Publication
(10) Pub. No.: US 2023/0148250 A1
(43) Pub. Date: May 11, 2023

(54) VISION RESTORATION DEVICE AND METHOD FOR USING VISION RESTORATION DEVICE

(71) Applicant: Medcure Inc., Tamana-shi (JP)

(72) Inventor: Masaru NUMAGAKI, Tamana-shi (JP)

(21) Appl. No.: 17/911,642

(22) PCT Filed: Apr. 10, 2020
(86) PCT No.: PCT/JP2020/016084

§ 371 Date: Sep. 14, 2022

(51) Int. Cl. A61H 5/00

(52) U.S. Cl. CPC A61H 5/00; A61H 2201/169; A61H 2201/0153; A61H 2201/1671

(57) ABSTRACT

A vision restoration device includes a body part and an eye piece part. The body part has a tubular holding part and a bottom part closing one end of the holding part. The eye piece part has a shape that fits the shape of eyelids covering an eyeball of a user, and has a projecting part that projects outward of the body part. In using the vision restoration device, the eye piece part is brought into contact with the eyelids to be massaged with the projecting part oriented toward a predetermined direction, and the vision restoration device is rotated, slid, or reciprocated.

### TECHNICAL FIELD

The present invention relates to a vision restoration device and a method for using the vision restoration device. Specifically, the present invention relates to a vision restoration device and to a method for using the vision restoration device that can be easily used by anyone and can restore vision by relaxing the muscles responsible for eyeball movement without imposing an excessive burden on the eyeball.

### BACKGROUND ART

In recent years, many electronic devices such as smartphones, personal computers, tablets, and electronic books have become widespread and usage time has rapidly increased, so that a heavy burden is imposed on the eyeballs of modern-day people on a daily basis. By continuing to look at such an electronic device for a long time, it is considered that the muscles for adjusting the focusing function of the eyeball remain contracted and do not return to their original state due to fatigue or stiffness and the focus adjustment function of the eyeball is lowered and thus vision decreases.

As described above, the environment surrounding the eyes of modern-day people is becoming more and more severe, with additional excessive stress and lifestyle habit disorders, the result of which is that it has become very difficult for modern-day people to maintain the health of their eyes. The decrease in vision caused under such conditions hinders work productivity and operational efficiency, and thus, it can be said that it is a problem for the whole of society. Therefore, taking effective measures to improve decreased vision is one of the most important challenges in modern society.

Eyeglasses, contact lenses, etc., have been conventionally used for vision correction of myopia, hyperopia, astigmatism, etc. However, they are troublesome to put on and take off, and have the inconvenience of not being usable by persons who play active sports and persons who have an occupation requiring naked eye vision.

Further, myopia correction surgery using a laser beam, called LASIK, is also performed. In this method, a diameter of about 3 mm to 15 mm is shaved off around a central portion of the cornea, the pupil, by a laser beam, and a front tip portion of the cornea is excised so as to be flattened or concave. As a result, the cornea acts as a concave lens, the light entering the eye is refracted, and the focus of the field-of-view image is formed on the retina.

However, this medical treatment requires advanced skills by a doctor, has high risk, and requires a follow-up post-surgery in some cases. Further, there is a problem that if the surgery is unsuccessful, the cornea cannot be returned to its original state, and there is also a problem that the depth of shaving off the cornea is limited and it is not effective for severe myopia.

Therefore, a vision restoration device as disclosed in, for example, Patent Literature 1 has been proposed. The vision restoration device disclosed in Patent Literature 1 is composed of a first translucent display portion, a second display portion provided behind the first display portion at a predetermined distance, and a switching means for switching images each displayed on the first display portion and the second display portion. A user alternately looks at a short-distance image displayed on the first display portion and a long-distance image displayed on the second display to promote the movement of the ciliary muscle.

Further, Patent Literature 2 discloses a device for performing vision restoration training while moving a display portion for displaying a mark for vision restoration training between a near point and a far point. Specifically, the display portion is controlled so that the display of the mark serving as a target changes in the display portion that moves between the near point and the far point. As a result, although a user needs to keep looking at the mark during training, the mark changes from moment to moment so that the user can carry out the training while maintaining concentration without becoming bored.

### CITATION LIST

### Patent Literature

Patent Literature 1: Japanese Published Unexamined Patent Application No. 2005-324006
Patent Literature 2: Japanese Published Unexamined Patent Application No. 2010-137011

### SUMMARY OF INVENTION

### Technical Problem

However, the vision restoration devices disclosed in Patent Literature 1 and Patent Literature 2 have the following problems. That is, in the conventional vision restoration devices, a monitor as the display portion, a projector for displaying an image on the monitor, etc., are required, so that the entire device becomes expensive and large in size. Thus, the devices are installed at an ophthalmic hospital, a training facility for vision restoration, etc., and the user needs to periodically visit the facility, etc., to perform the vision restoration training. Therefore, when the user cannot visit the training facility, the user cannot receive periodic training, and the vision restoration effect cannot be greatly expected.

Further, in recent years, there is a demand to perform the vision restoration training easily at home, at school, at work, etc., under circumstances where, vision tends to decrease not only among adults but also among elementary and junior high school students and the number of people who require the vision restoration training is increasing.

Incidentally, the eyeball has a structure of having the cornea on the front surface and having the crystalline lens, the vitreous body, the retina, etc., behind the cornea. The movement of the eyeball is controlled by the extraocular muscles responsible for mainly the eyeball movement and the ciliary muscle for adjusting the thickness of the crystalline lens. The field-of-view image entering through the cornea is focused by the crystalline lens, and then, formed on the retina through the vitreous body, and transmitted to the brain center by the nerves continuing to the retina.

Here, it is said that there are two types of myopia, axial myopia and refractive myopia. Axial myopia refers to a symptom in which the vertical axis of the eye called the axial length is elongated to focus in front of the retina and a far object is not clearly visible. On the other hand, refractive myopia refers to a symptom in which, by continuing to look near, the crystalline lens swells and does not return to its original state, the result of which is that a far object is not clearly visible. In general, the myopia treatment means a treatment for refractive myopia, and Patent Literature 1 and Patent Literature 2 also assume refractive myopia. Under the present circumstances, no treatment method for axial myopia has been established.

In this regard, the present inventor hypothesized as follows as a factor for developing myopia. That is, modern-day people tend to keep looking at electronic devices including smartphones for a long time as described above, and the line of sight at this time is maintained in a posture slightly downward from the front. When the line of sight becomes downward, an excessive burden is imposed on particularly the superior oblique muscle among the extraocular muscles that suspend the eyeball, and the trochlea that suspends the superior oblique muscle. Due to the superior oblique muscle not returning to its original state while remaining in a contracted tense state, the eyeball is attracted toward the direction of the trochlea and becomes elliptical combined with interpolation of the fat in the orbit. The present inventor considered this as a major factor for myopia.

As a result of extensive research, the present inventor confirmed that by applying from outside an appropriate stimulus to the superior oblique muscle and the trochlea that suspends the superior oblique muscle, the tense muscle is relaxed and the elliptical eyeball can be returned to a state close to a perfect circle, the result of which is that the effect of restoring vision is obtained even with axial myopia.

The present invention has been made in view of the foregoing points, and an object thereof is to provide a vision restoration device and a method for using the vision restoration device that can be easily used by anyone and can restore vision by relaxing the muscles responsible for eyeball movement without imposing an excessive burden on the eyeball.

### Solution to Problem

In order to achieve the foregoing object, a vision restoration device of the present invention includes a bottom part, a tubular holding part extending from a periphery of the bottom part and capable of being held with fingers, and an eye piece part formed on an open end edge of the holding part and having a shape that fits the eyelids covering an eyeball.

Here, the vision restoration device includes the tubular holding part, so that the user can operate the vision restoration device while holding the holding part with fingers. Therefore, the user can easily massage the eyeball using the vision restoration device while staying at home or at work.

Further, the open end edge of the holding part is provided with the eye piece part having a shape that fits the eyelids covering the eyeball, so that the eye piece part can be brought into close contact with the eyelids. Therefore, when the periphery of the eyeball is massaged using the vision restoration device, the adhesion between the eye piece part and the eyelids can be maintained, so that the massage effect can be enhanced.

Further, when a projecting part projecting outward from the holding part is provided at a predetermined position of the eye piece part, the adhesion between the eye piece part and the eyelids can be further enhanced by causing the projecting part to abut against a skin surface corresponding to the orbit around the eyelids. Further, the massage can be performed using the orientation of the projecting part as a mark, so that the user can easily perform the massage even alone.

Further, when the eye piece part is made of synthetic resin, the synthetic resin is a flexible material, so that even if a part of the vision restoration device comes into contact with the eyeball during the massage, there is no risk of damaging the eyeball and the surrounding skin surface since the eye piece portion itself is deformed in shape. Since the synthetic resin has a high coefficient of friction, an external force can be easily transmitted to the eyelids to enhance the massage effect.

In order to achieve the foregoing object, a method for using a vision restoration device of the present invention is a method for using a vision restoration device including a bottom part, a tubular holding part extending from a periphery of the bottom portion and capable of being held with fingers, and an eye piece part formed on an open end edge of the holding part and having a shape that fits the eyelids covering an eyeball, the method including a contacting step of bringing the eye piece part into contact with the eyelids of one eye of a user, a sliding step of sliding the vision restoration device by a predetermined range toward a direction of an outer corner of the one eye from a state in which the eye piece part is in contact, and a maintaining step of maintaining, for a predetermined time, a state in which the vision restoration device is slid.

Here, by providing the contacting step of bringing the eye piece part of the vision restoration device into contact with the eyelids of one eye of the user, the vision restoration device can be brought into close contact with the eyelids of one eye of the user to be massaged. At this time, since the eye piece part has the shape that fits the eyelids, the adhesion between the eye piece part and the eyelids can be enhanced. Therefore, when the periphery of the eyeball is massaged using the vision restoration device, the adhesion between the eye piece part and the eyelids can be maintained, so that the massage effect can be enhanced.

Further, by providing the sliding step of sliding the vision restoration device toward the direction of the outer corner of the eye from the state in which the eye piece part is in contact, the superior oblique muscle on which a tension force toward the direction of the trochlea of the eyeball acts can be applied with a tension force in a direction opposite to the direction of the trochlea. As a result, the superior oblique muscle is stretched, and the tense superior oblique muscle can be relaxed. In addition, the eyeball deformed into the elliptical shape by being pressed by the superior oblique muscle or the inferior oblique muscle can be returned to a state close to a perfect circle, so that vision can be restored.

Further, by providing the maintaining step of maintaining, for a predetermined time, the state in which the vision restoration device is slid, the tense superior oblique muscle can be relaxed by applying the tension force in the direction opposite to the direction of the trochlea to the superior oblique muscle for a certain period of time.

Further, when the sliding step slides the vision restoration device in a range of about 1 to 2 cm, the massage effect on the superior oblique muscle can be enhanced. When the slide range of the vision restoration device is less than 1 cm, the massage effect on the superior oblique muscle is weak and the vision restoration effect cannot be expected. On the other hand, when the slide range of the vision restoration device is larger than 2 cm, the tension force acting on the superior oblique muscle may become excessively large, resulting in muscle pain.

Further, when the state in which the vision restoration device is slid is maintained for about 10 to 20 seconds, the massage effect on the superior oblique muscle can be enhanced. When the time for maintaining the state in which the vision restoration device is slid is less than 10 seconds, the massage effect on the superior oblique muscle is weak and the vision restoration effect cannot be expected. On the other hand, there is no significant difference in the massage effect when the time for maintaining the state in which the vision restoration device is slid exceeds 20 seconds. Therefore, about 10 to 20 seconds are most appropriate as the time for maintaining the state in which the vision restoration device is slid.

When a projecting part projecting outward from the holding part is provided at a predetermined position of the eye piece part and the contacting step is performed with the projecting part oriented toward the direction of the outer corner of the eye, the projecting part abuts against a skin surface corresponding to the orbit in the vicinity of the outer corner of the eye with the eye piece part in contact with the eyelids, so that the eye piece part can be prevented from being caught in the orbit when the vision restoration device is slid, and smooth sliding movement can be realized.

When the sliding step and the maintaining step are repeated at least twice, the massage effect on the superior oblique muscle can be enhanced. When the sliding step and the maintaining step are performed once each, the massage effect is weak and the vision restoration effect cannot be expected. On the other hand, even if the sliding step and the maintaining step are repeated three or more times, there is no significant difference in the massage effect. Therefore, it is most appropriate to repeat the sliding step and the maintaining step twice.

In order to achieve the foregoing object, a method for using a vision restoration device of the present invention is a method for using a vision restoration device including a bottom part, a tubular holding part erected from a periphery of the bottom part and capable of being held with fingers, and an eye piece part formed on an open end edge of the holding part and having a shape that fits the eyelids covering an eyeball, the method including a contacting step of bringing the eye piece part into contact with the eyelids of one eye of a user, a rotating step of rotating the vision restoration device in a range of an acute angle in a direction of an outer corner of the one eye from a state in which the eye piece part is in contact, and a maintaining step of maintaining, for a predetermined time, the state in which the vision restoration device is rotated.

Here, by providing the contacting step of bringing the eye piece part of the vision restoration device into contact with the eyelids of one eye of the user, the vision restoration device can be brought into close contact with the eyelids of one eye of the user to be massaged. At this time, the eyepiece part has the shape that fits the eyelids, so that the adhesion between the eye piece part and the eyelids can be enhanced. Therefore, when the periphery of the eyeball is massaged using the vision restoration device, the adhesion between the eye piece part and the eyelids can be maintained, so that the massage effect can be enhanced.

Further, by providing the rotating step of rotating the vision restoration device in the range of an acute angle in the direction of the outer corner of the eye from the state in which the eye piece part is in contact, the superior oblique muscle on which the tension force toward the direction of the trochlea of the eyeball acts can be applied with an outward rotational force in a direction opposite to the direction of the trochlea. As a result, the superior oblique muscle is stretched, and the tense superior oblique muscle can be relaxed. In addition, the eyeball deformed into the elliptical shape by being pressed by the superior oblique muscle or the inferior oblique muscle can be returned to a state close to a perfect circle, so that vision can be restored.

Further, by providing the maintaining step of maintaining, for a predetermined time, the state in which the vision restoration device is rotated, the tense superior oblique muscle can be relaxed by applying the rotational force to the superior oblique muscle for a certain period of time.

Further, when the rotating step rotates the vision restoration device in a range of about 30° to 45°, the massage effect on the superior oblique muscle can be enhanced. When the rotation range of the vision restoration device is less than 30°, the massage effect on the superior oblique muscle is weak and the vision restoration effect cannot be expected. On the other hand, when the rotation range of the vision restoration device is larger than 45°, the tension force acting on the superior oblique muscle due to the rotation may become excessively large, resulting in muscle pain.

Further, when the state in which the vision restoration device is rotated is maintained for about 10 to 20 seconds, the massage effect on the superior oblique muscle can be enhanced. When the time for maintaining the state in which the vision restoration device is rotated is less than 10 seconds, the massage effect on the superior oblique muscle is weak and the vision restoration effect cannot be expected. On the other hand, there is no significant difference in the massage effect when the time for maintaining the state in which the vision restoration device is rotated exceeds 20 seconds. Therefore, about 10 to 20 seconds are most appropriate as the time for maintaining the state in which the vision restoration device is rotated.

Further, when a projecting part projecting outward from the holding part is provided at a predetermined position of the eye piece part and the contacting step is performed with the projecting part oriented upward in front view, the vision restoration device can be rotated using the projecting part as an index. That is, when the vision restoration device is rotated, the rotation angle of the vision restoration device can be grasped by checking the inclination of the projecting part with a mirror, etc., so that the massage can be effectively performed.

When the rotating step and the maintaining step are repeated at least three times, the massage effect on the superior oblique muscle can be enhanced. When the rotating step and the maintaining step are repeated only twice, the massage effect is weak and the vision restoration effect cannot be expected. On the other hand, even if the rotating step and the maintaining step are repeated four or more times, there is no significant difference in the massage effect. Therefore, it is most appropriate to repeat the rotating step and the maintaining step three times.

In order to achieve the foregoing object, a method for using a vision restoration device of the present invention is a method for using a vision restoration device including a bottom part, a tubular holding part extending from a periphery of the bottom part and capable of being held with fingers, and an eye piece part formed on an open end edge of the holding part and having a shape that fits the eyelids covering an eyeball, the method including a contacting step of bringing the eye piece part into contact with a periphery of the eyelids of one eye of a user and a reciprocating step of reciprocating the vision restoration device in a constant cycle in two directions, a direction of an outer corner of the one eye and a direction of an inner corner of the one eye, from a state in which the eye piece part is in contact.

Here, by providing the contacting step of bringing the eye piece part of the vision restoration device into contact with the eyelids of one eye of the user, the vision restoration device can be brought into close contact with the eyelids of one eye of the user to be massaged. At this time, since the eye piece part has the shape that fits the eyelids, the adhesion between the eye piece part and the eyelids can be enhanced. Therefore, when the periphery of the eyeball is massaged using the vision restoration device, the adhesion between the eye piece part and the eyelids can be maintained, so that the massage effect can be enhanced.

Further, by providing the reciprocating step of reciprocating the vision restoration device in a constant cycle in two directions, the direction of the outer corner of the eye and the direction of the inner corner of the eye, from the state in which the eye piece part is in contact, the massage effect on the trochlea that suspends the superior oblique muscle can be enhanced. At this time, the trochlea is located at an upper portion of the inner corner of the eye inside the orbit, so that the massage effect can be further enhanced by reciprocating the vision restoration device so as to include the inner corner part of the eye as much as possible.

Further, when the reciprocating step is continued for about 10 to 20 seconds, the massage effect on the trochlea can be enhanced. When the time for performing the reciprocating step is less than 10 seconds, the massage effect on the trochlea is weak and the vision restoration effect cannot be expected. On the other hand, there is no significant difference in the massage effect when the time for performing the reciprocating step exceeds 20 seconds. Therefore, about 10 to 20 seconds are most appropriate as the time for performing the reciprocating step.

When a projecting part projecting outward from the holding part is provided at a predetermined position of the eye piece part and the step of bringing the eye piece part into contact with the periphery of the eyelids of one eye of the user is performed with the projecting part oriented toward the direction of the outer corner of the eye, the projecting part abuts against a skin surface corresponding to the orbit in the vicinity of the outer corner of the eye with the eye piece part in contact with the eyelids, so that the eye piece part can be prevented from being caught in the orbit when the vision restoration device is reciprocated, and smooth reciprocation can be realized.

### Advantageous Effects of Invention

The vision restoration device and the method for using the vision restoration device according to the present invention can be easily used by anyone and can restore vision by relaxing the muscles responsible for eyeball movement without imposing an excessive burden on the eyeball.

### BRIEF DESCRIPTION OF DRAWINGS

FIG. 1 is a diagram showing a vision restoration device according to an embodiment of the present invention.

FIG. 2 is a diagram showing a state in which the vision restoration device according to the embodiment of the present invention is attached to a user.

FIG. 3 is a diagram showing a relationship between extraocular muscles and an eyeball (right eye).

FIG. 4 is a diagram showing a method for using the vision restoration device according to an embodiment of the present invention (massage method 1).

FIG. 5 is a diagram showing a method for using the vision restoration device according to an embodiment of the present invention (massage method 2).

FIG. 6 is a diagram showing a method for using the vision restoration device according to an embodiment of the present invention (massage method 3).

### DESCRIPTION OF EMBODIMENTS

Hereinafter, a vision restoration device and a method for using the vision restoration device according to embodiments of the present invention will be described with reference to the drawings to provide an understanding of the present invention.

[Vision Restoration Device]

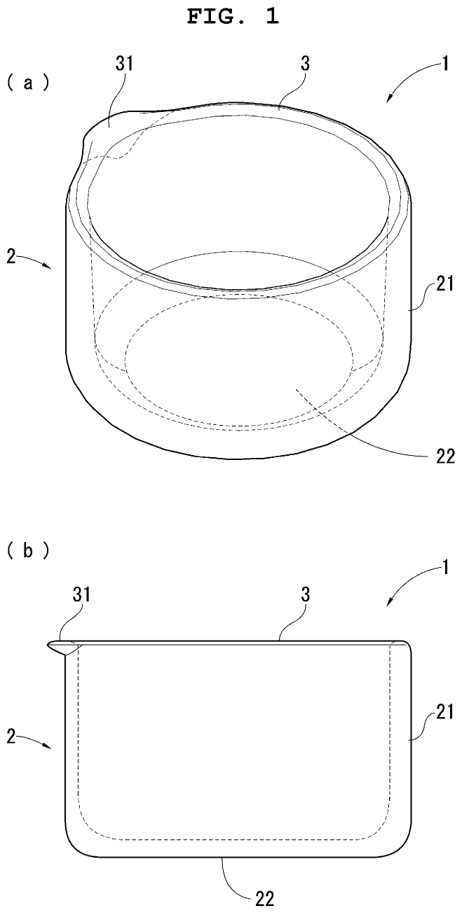

First, a vision restoration device according to an embodiment of the present invention will be described based on FIG. 1. As shown in FIG. 1, the vision restoration device 1 is mainly composed of a body part 2 and an eye piece part 3.

The body part 2 has a tubular holding part 21 and a bottom part 22 closing the other end of the holding part 21. That is, the body part 2 has a shape erected upward from a periphery of the bottom part 22 with the circular bottom part 22 placed on the floor surface.

Here, the body part 2 does not necessarily have to have a cylindrical tubular shape as shown in FIG. 1. For example, it may have a rectangular or elliptical tubular shape. However, as will be described later, the shape of the body part 2 is preferably a cylindrical tubular shape in order to enhance the operability when the extraocular muscles of the user are massaged using the vision restoration device 1.

The eye piece part 3 is continuously connected to the holding part 21 on an open end edge of the body part 2. The eye piece part 3 has a shape that fits the shape of eyelids covering an eyeball of a user. In order to enhance the adhesion of the eye piece part 3 when the eye piece part 3 abuts against the eyelids of the user, the eye piece part 3 has a shape spreading slightly outward.

Here, the body part 2 and the eye piece part 3 do not necessarily have to be integrated, and the eye piece part 3 may be configured to be attachable/detachable with respect to the body part 2. By configuring the eye piece part 3 to be attachable to/detachable from the body part 2 as described above, only the eye piece part 3 can be replaced when the eye piece part 3 deteriorates.

A projecting part 31 is integrally formed at a predetermined position in a circumferential direction of the eye piece part 3. The projecting part 31 has a shape projecting outward with a length of approximately 5.0 mm relative to the maximum width of the eye piece part 3.

Here, the projecting part 31 does not necessarily have to be formed at the eye piece part 3. However, by the projecting part 31 being formed, the massage can be performed using the position of the projecting part 31 as a mark. Further, when the eye piece part 3 is brought into contact with the eyelids of the user, the projecting part 31 abuts against a skin surface corresponding to an orbit around the eyelid. Thus, even when the vision restoration device 1 is slid or reciprocated from the state in which the eye piece part 3 is in contact with the eyelids of the user, the eye piece part 3 can be prevented from being caught in the orbit to realize smooth operation.

The body part 2 and the eye piece part 3 are made of a synthetic resin material such as polyethylene or silicone. The body part 2 and the eye piece part 3 may be made of different materials.

Here, the material constituting the body part 2 and the eye piece part 3 does not necessarily have to be a synthetic resin material. However, by constituting the body part 2 and the eye piece part 3 with a soft material such as a synthetic resin material, the adhesion between the eyeball and the vision restoration device 1 when the periphery of the eyeball is massaged using the vision restoration device 1 can be enhanced, and the massage effect can be enhanced. In addition, by constituting them with a soft material, the eyeball is not damaged even if the vision restoration device 1 is erroneously operated to come into contact with the eyeball in massaging, so that safety can be secured.

Further, the body part 2 and the eye piece part 3 do not necessarily have to be made of different materials, and the body part 2 and the eye piece part 3 may be made of the same material. However, when the body part 2 and the eye piece part 3 are separately formed, for example, the eye piece part 3 is made of a soft material with respect to the body part 2, thereby allowing the adhesion of the eye piece part 3 with respect to the body part 2 to be enhanced. Therefore, the eye piece part 3 can be prevented from breaking and separating from the body part 2 during use of the vision restoration device 1 to enhance the durability of the vision restoration device 1.

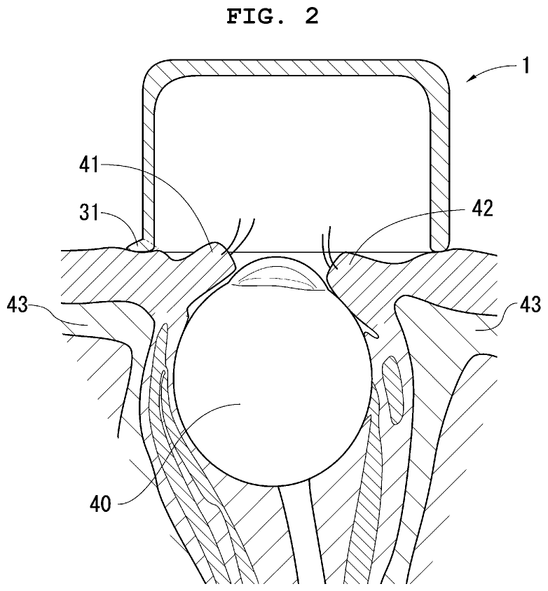

FIG. 2 is a diagram illustrating, from the right side, a state in which the vision restoration device 1 is brought into contact with the eyelids of the user. When the vision restoration device 1 is used, the eye piece part 3 is brought into contact with an upper eyelid 41 and a lower eyelid 42 of one eyeball 40 (the right eye in FIG. 2) to be massaged. More specifically, as shown in FIG. 2, the eye piece part 3 fits into a recess between the eyeball 40 and an orbit 43, so that the adhesion with the eye piece part 3 can be enhanced. At this time, the projecting part 31 abuts against the skin surface corresponding to the orbit 43 (upper portion of the upper eyelid 41 in FIG. 2). Thus, even when the vision restoration device 1 is slid or reciprocated, smooth movement is allowed without the eye piece part 3 being caught in the recess of the orbit 43.

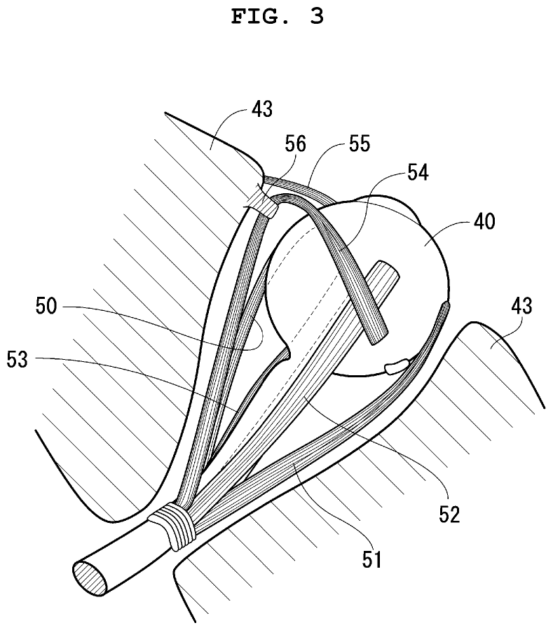

The above is the configuration of the vision restoration device 1 according to the embodiment of the present invention. Here, the mechanism of myopia will be briefly described. First, the relationship between an eyeball and extraocular muscles will be described using FIG. 3 (FIG. 3 shows an eyeball on the right side). The extraocular muscles are composed of six eye muscles of four rectus muscles (medial rectus muscle 50, lateral rectus muscle 51, superior rectus muscle 52, and inferior rectus muscle 53) and two oblique muscles (superior oblique muscle 54 and inferior oblique muscle 55).

These six extraocular muscles are moved by nerves from the brain. Specifically, the medial rectus muscle 50 is a muscle that directs the eyeball in an inward direction, and is governed by the oculomotor nerve. The lateral rectus muscle 51 is a muscle that directs the eyeball 40 in an outward direction, and is governed by the abducent nerve. The superior rectus muscle 52 and the inferior rectus muscle 53 are governed by the oculomotor nerve like the medial rectus muscle 50 and are muscles that direct the eyeball 40 up and down. The superior oblique muscle 54 is a muscle that rotates the eyeball 40 inward, and the inferior oblique muscle 55 is a muscle that rotates the eyeball 40 outward. Further, the superior oblique muscle 54 is suspended by a trochlea 56 and is governed by the trochlear nerve, and the inferior oblique muscle 55 is governed by the oculomotor nerve.

A force in the direction of the trochlea always acts on the superior oblique muscle 54. When a downward posture is taken at the time of browsing an electronic device or the like, for example, a force in the direction of the trochlea of the eyeball 40 is further generated in the superior oblique muscle 54. By continuing the downward posture for a long time, the force acting on the superior oblique muscle 54 becomes excessive and the superior oblique muscle 54 is stiffened while remaining tense.

When the superior oblique muscle 54 is stiffened, the eyeball 40, which should be originally a perfect circle, continues to be excessively pulled and is deformed into an elliptical shape. As a result, it is conceived that the focus of the eyeball at the time of looking at a distance becomes difficult to adjust and a symptom of myopia occurs. Accordingly, it is expected that by appropriately massaging the stiffened superior oblique muscle 54 and trochlea 56 suspending the superior oblique muscle 54, the tense superior oblique muscle 54 and trochlea 56 are relaxed to return the eyeball to its original perfect circle state, thereby improving the symptom of myopia.

Hereinafter, as a method for using the vision restoration device 1, methods for massaging the superior oblique muscle 54 and the trochlea 56 will be described. In the following description, the user of the vision restoration device 1 and the person to be treated are the same person, and each direction shown in the description is based on the viewpoint of the user.

[Massage Method 1]

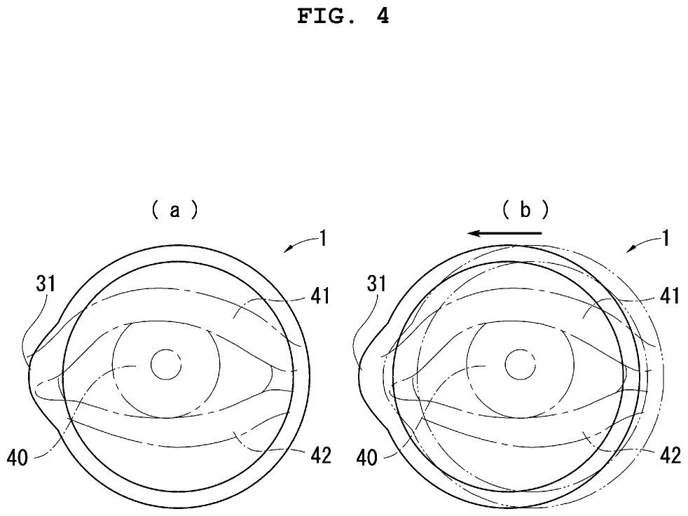

Based on FIG. 4, a massage method 1 will be described. The massage method 1 is a method for using the vision restoration device 1 for relaxing the superior oblique muscle.

First, the user holds the holding part 21 of the vision restoration device 1 with one hand, and as shown in FIG. 4 (a), the eye piece part 3 is brought into contact with the eyelids of the right eye to be massaged with the projecting part 31 oriented toward the direction of the outer corner of the right eye. At this time, as shown in FIG. 2 described above, the eye piece part 3 is brought into close contact so that the eye piece part 3 fits into the recess between the eyeball 40 and the orbit 43.

Next, with the eye piece part 3 in close contact with the upper eyelid 41 and the lower eyelid 42, the vision restoration device 1 is slid toward the right by about 1 to 2 cm as shown in FIG. 4 (b), and the slid state is maintained for about 10 to 20 seconds (hereinafter, the movement of sliding the vision restoration device and maintaining the state is collectively referred to as “sliding movement”). At this time, a tensile force in the right direction acts on the superior oblique muscle as well as the eyelids, and a force in a direction opposite to the direction of the trochlea can be applied to the superior oblique muscle, so that the stiffened superior oblique muscle can be relaxed.

When the sliding distance becomes long, the burden on the superior oblique muscle becomes excessive, which may cause muscle pain. On the other hand, when the sliding distance is short, the massage effect on the superior oblique muscle becomes weak. Thus, according to the result of the study by the inventor, as the sliding distance, it is preferable to slide the vision restoration device in a range of about 1 to 2 cm as a guide.

Further, when the vision restoration device 1 is slid, the eye piece part 3 is in close contact so as to fit into the recess between the eyeball 40 and the orbit 43 while the projecting part 31 is in a state of abutting against the skin surface corresponding to the orbit 43. Therefore, smooth sliding movement can be realized without the eye piece part 3 being caught in the orbit 43.

By repeating the aforementioned sliding movement about twice, the superior oblique muscle stiffened in the state in which the strong force is applied in the direction of the trochlea of the eyeball can be relaxed.

Here, the number of repetitions of the sliding movement does not necessarily have to be two times. It can be changed as appropriate according to the condition of the eyeball, the physical condition, etc., of the user. The vision restoration effect cannot be expected when the sliding movement is performed only once, and many repetitions of the sliding movement may cause muscle pain. In this regard, according to the result of the study by the inventor, about twice is most effective as the number of repetitions of the sliding movement.

[Massage Method 2]

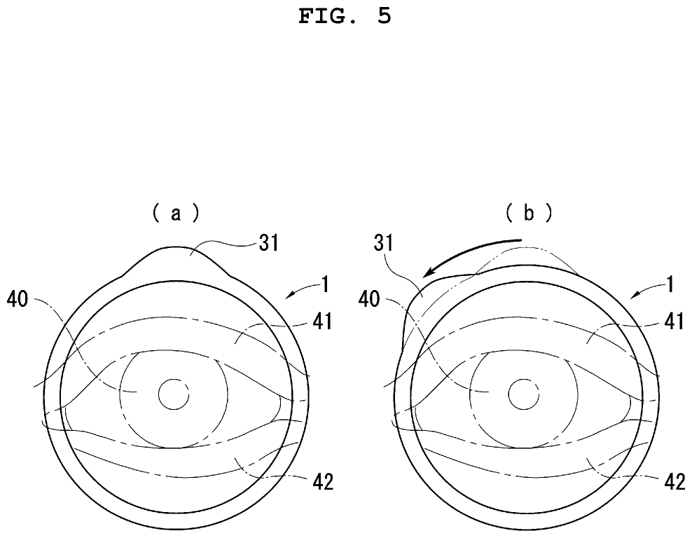

Based on FIG. 5, a massage method 2 will be described. The massage method 2 is a method for using the vision restoration device 1 for relaxing the superior oblique muscle similar to the massage method 1.

First, the user holds the holding part 21 of the vision restoration device 1 with one hand, and as shown in FIG. 5(a), the eye piece part 3 is brought into contact with the upper eyelid 41 and the lower eyelid 42 of the right eye to be massaged with the projecting part 31 oriented upward. At this time, as shown in FIG. 2 described above, the eye piece part 3 is brought into close contact so that the eye piece part 3 fits into the recess between the eyeball 40 and the orbit 43.

Next, with the eye piece part 3 in close contact with the eyelids, the vision restoration device is rotated in the right direction (direction of the outer corner of the eye) as shown in FIG. 5(b) and the rotated state is maintained for about 10 to 20 seconds (hereinafter, the movement of rotating the vision restoration device and maintaining the state is collectively referred to as “rotational movement”). At this time, a tensile force to the rotation direction acts on the superior oblique muscle as well as the eyelids, whereby a force in a direction opposite to the direction of the trochlea of the eyeball can be applied to the superior oblique muscle, so that the stiffened superior oblique muscle can be relaxed.

When the angle to be rotated is large, the burden on the superior oblique muscle becomes excessive, which may cause muscle pain. On the other hand, when the angle to be rotated is small, the massage effect on the superior oblique muscle becomes weak. Thus, according to the result of the study by the inventor, as the rotation angle, it is preferable to rotate the vision restoration device in a range of about 30° to 45° as a guide. In that case, the user can grasp an approximate rotation angle by checking the position of the projecting part 31 with a mirror, for example.

By repeating the aforementioned rotational movement about three times, the superior oblique muscle stiffened in the state in which the strong force is applied in the direction of the trochlea of the eyeball can be relaxed.

Here, the number of repetitions of the rotational movement does not necessarily have to be three times. It can be changed as appropriate according to the condition of the eyeball, the physical condition, etc., of the user. The vision restoration effect cannot be expected when the number of repetitions of the rotational movement is less than three times, and many repetitions of the rotational movement may cause muscle pain. In this regard, according to the result of the study by the inventor, about three times is most effective as the number of repetitions of the rotational movement.

[Massage Method 3]

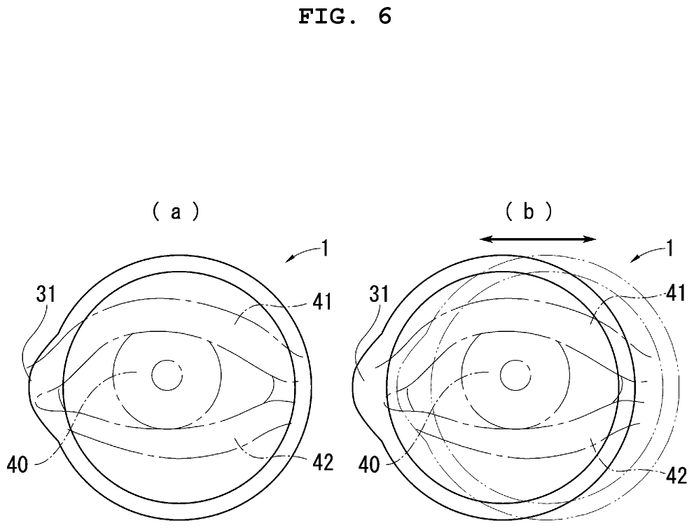

Based on FIG. 6, a massage method 3 will be described. The massage method 3 is a method for using the vision restoration device 1 for relaxing the trochlea.

First, the user holds the holding part 21 of the vision restoration device 1 with one hand, and as shown in FIG. 6(a), the eye piece part 3 is brought into contact with the upper eyelid 41 and the lower eyelid 42 of the right eye to be massaged with the projecting part 31 oriented toward the direction of the outer corner of the right eye. At this time, as shown in FIG. 2 described above, the eye piece part 3 is brought into close contact so that the eye piece part 3 fits into the recess between the eyeball 40 and the orbit 43.

Next, with the eye piece part 3 in close contact with the eyelids, the vision restoration device 1 is reciprocated in the left-right direction (direction of the inner corner of the eye and direction of the outer corner of the eye) in a constant cycle for about 20 seconds as shown in FIG. 6(b) (hereinafter, referred to as “reciprocating movement”). At this time, a stimulus can be applied to the trochlea suspending the superior oblique muscle, so that the stiffened trochlea can be relaxed.

When the time of the reciprocating movement becomes long, the burden on the trochlea becomes excessive, which may cause muscle pain. On the other hand, when the time of the reciprocating movement is short, the massage effect on the trochlea becomes weak. Thus, according to the result of the study by the inventor, as one reciprocating movement, it is preferable to use about 10 to 20 seconds as a guide.

Further, when the vision restoration device 1 is reciprocated, the eye piece part 3 is in close contact so as to fit into the recess between the eyeball 40 and the orbit 43 while the projecting part 31 is in a state of abutting against the skin surface corresponding to the orbit 43. Therefore, smooth reciprocating movement can be realized without the eye piece part 3 being caught in the orbit.

Next, test examples for confirming the vision restoration effect by the massage methods using the vision restoration device 1 described above will be described.

In each test example, males and females in their teens to 40s were asked as test subjects to perform a massage method using the vision restoration device 1, and the vision restoration effect was confirmed.

### Test Example A

As Test Example A, the test subjects were asked to perform the massage method 1 twice a day (at predetermined times in the morning and evening) every day for three consecutive months, and the vision restoration effect was confirmed. The results are shown in Table 1.

TABLE 1

| | Eyesight value | Eyesight value |
|---|---|---|
| | before treatment | after treatment |
| Male in 10s | 0.3 | 0.7 |
| Female in 20s | 0.1 | 0.6 |
| Female in 20s | 0.5 | 1.0 |
| Female in 30s | 0.3 | 0.8 |
| Male in 40s | 0.4 | 0.8 |

### Test Example B

As Test Example B, the test subjects were asked to perform the massage method 2 twice a day (at predetermined times in the morning and evening) every day for three consecutive months, and the vision restoration effect was confirmed. The results are shown in Table 2.

TABLE 2

| | Eyesight value | Eyesight value |
|---|---|---|
| | before treatment | after treatment |
| Female in 10s | 0.2 | 0.4 |
| Female in 20s | 0.4 | 0.6 |
| Male in 20s | 0.1 | 0.3 |
| Female in 30s | 0.6 | 0.9 |
| Male in 40s | 0.6 | 0.7 |

### Test Example C

As Test Example C, the test subjects were asked to perform the massage method 3 twice a day (at predetermined times in the morning and evening) every day for three consecutive months, and the vision restoration effect was confirmed. The results are shown in Table 3.

TABLE 3

| | Eyesight value | Eyesight value |
|---|---|---|
| | before treatment | after treatment |
| Male in 10s | 0.5 | 0.6 |
| Female in 20s | 0.3 | 0.5 |
| Male in 20s | 0.4 | 0.6 |
| Male in 30s | 0.3 | 0.4 |
| Female in 40s | 0.8 | 0.9 |

### Test Example D

As Test Example D, the test subjects were asked to perform the massage method 1 to the massage method 3 as a set in one massage, twice a day (at predetermined times in the morning and evening) every day for three consecutive months, and the vision restoration effect was confirmed. The results are shown in Table 4.

TABLE 4

| | Eyesight value | Eyesight value |
|---|---|---|
| | before treatment | after treatment |
| Female in 10s | 0.4 | 1.0 |
| Female in 10s | 0.4 | 1.2 |
| Female in 40s | 0.2 | 0.7 |
| Male in 40s | 0.5 | 1.2 |
| Male in 40s | 0.2 | 0.8 |

According to Test Examples A to C, it is found that the massage method 1 has the highest vision restoration effect on average although there are individual differences depending on the test subjects. Further, according to Test Example D, it is found that a higher vision restoration effect can be expected when the massage method 1 is mainly used in combination with the massage method 2 and the massage method 3.

As described above, the vision restoration device and the method for using the vision restoration device according to the present invention can be easily used by anyone and can restore vision by relaxing the muscles responsible for eyeball movement without imposing an excessive burden on the eyeball.

### REFERENCE SIGNS LIST

1 Vision restoration device
2 Body part
21 Holding part
22 Bottom part
3 Eye piece part
31 Projecting part
40 Eyeball
41 Upper eyelid
42 Lower eyelid
43 Orbit
50 Medial rectus muscle
51 Lateral rectus muscle
52 Superior rectus muscle
53 Inferior rectus muscle
54 Superior oblique muscle
55 Inferior oblique muscle
56 Trochlea

1. A vision restoration device comprising:
a bottom part;
a tubular holding part extending from a periphery of the bottom part and configured to be held with fingers; and
an eye piece part located on an open end opposite of the bottom part of the tubular holding part and having a shape that fits the eyelids covering an eyeball.

2. The vision restoration device according to claim 1, wherein the eye piece part comprises a projecting part projecting in an outward direction from the holding part at a predetermined position of the eye piece part.

3. The vision restoration device according to claim 1, wherein the eye piece part is made of synthetic resin.

4. A method for using a vision restoration device including a bottom part, a tubular holding part extending from a periphery of the bottom part and configured to be held with fingers, and an eye piece part located on an open end of the holding part and having a shape that fits the eyelids covering an eyeball, the method comprising:
a contacting step of bringing the eye piece part into contact with an upper eyelid and a lower eyelid of one eye of a user;
a sliding step of sliding the vision restoration device by a predetermined range toward a direction of an outer corner of the one eye from a state in which the eye piece part is in contact; and
a maintaining step of maintaining, for a predetermined time, a state in which the vision restoration device is slid.

5. The method for using the vision restoration device according to claim 4, wherein
during the sliding step, the vision restoration device is slid in a range of about 1 to 2 cm, and
during the maintaining step, the state is maintained for about 10 to 20 seconds.

6. The method for using the vision restoration device according to claim 4, wherein
a projecting part projecting in an outwardly direction from the holding part is provided at a predetermined position of the eye piece part, and
the contacting step is performed with the projecting part oriented toward the direction of the outer corner of the one eye.

7. The method for using the vision restoration device according to claim 4, wherein the sliding step and the maintaining step are repeated at least twice.

8. A method for using a vision restoration device including a bottom part, a tubular holding part extending from a periphery of the bottom part and configured to be held with fingers, and an eye piece part formed on an open end of the holding part and having a shape that fits the eyelids covering an eyeball, the method comprising:
a contacting step of bringing the eye piece part into contact with the eyelids of one eye of a user;
a rotating step of rotating the vision restoration device in a range of an acute angle in a direction of an outer corner of the one eye from a state in which the eye piece part is in contact; and
a maintaining step of maintaining, for a predetermined time, a state in which the vision restoration device is rotated.

9. The method for using the vision restoration device according to claim 8, wherein
during the rotating step, the range is about 30° to 45°, and
the maintaining step maintains that state for about 10 to 20 seconds.

10. The method for using the vision restoration device according to claim 8, wherein
a projecting part projecting in an outwardly direction from the holding part is provided at a predetermined position of the eye piece part, and
the contacting step is performed with the projecting part oriented upward in a front view.

11. The method for using the vision restoration device according to claim 8, wherein the rotating step and the maintaining step are repeated at least three times.

12. A method for using a vision restoration device including a bottom part, a tubular holding part extending from a periphery of the bottom part and configured to be held with fingers, and an eye piece part formed on an open end of the holding part and having a shape that fits the eyelids covering an eyeball, the method comprising:
a contacting step of bringing the eye piece part into contact with a periphery of the eyelids of one eye of a user; and
a reciprocating step of reciprocating the vision restoration device in a constant cycle in two directions including a direction of an outer corner of the one eye and a direction of an inner corner of the one eye, from a state in which the eye piece part is in contact.

13. The method for using the vision restoration device according to claim 12, wherein the reciprocating step is continued for about 10 to 20 seconds.

14. The method for using the vision restoration device according to claim 12, wherein
a projecting part projecting in an outwardly direction from the holding part is provided at a predetermined position of the eye piece part, and
the step of bringing the eye piece part into contact with the periphery of the eyelids of the one eye of the user is performed with the projecting part oriented toward the direction of the outer corner of the one eye.
